(19) United States
(12) Patent Application Publication
(10) Pub. No.: US 2010/0082763 A1
(43) Pub. Date: Apr. 1, 2010

(54) SYSTEM FOR CONTROLLING AN OPERATION ON A REMOTE SERVER ON THE BASIS OF A PHYSICAL ACTION EXERTED ON A DETERMINED ZONE OF A DOCUMENT

(75) Inventor: Laurent Farlotti, Pruniers (FR)

Correspondence Address: SUGHRUE MION, PLLC, 2100 PENNSYLVANIA AVENUE, N.W., SUITE 800, WASHINGTON, DC, 20037, US

(73) Assignee: NEOPOST TECHNOLOGIES, Bagneux (FR)

(21) Appl. No.: 12/511,541

(22) Filed: Jul. 29, 2009

(30) Foreign Application Priority Data
Aug. 1, 2008 (FR) 0855368

(51) Int. Cl. G06F 15/16

(52) U.S. Cl. 709/208

(57) ABSTRACT

System for automatically controlling an operation determined at the level of a computer server (20) on the basis of a physical action exerted on at least one determined zone of a document (10) extracted from an item of mail, system comprising:
a wireless communication circuit (16) activated by the actuation of at least one actuator (14-14F) integrated at the level of at least one determined zone of the document, and
a wireless access point router modem (24) for retransmitting to the computer server, via a communication network (22), a message received from the wireless communication circuit comprising at least one datum identifying a recipient of the document and a datum relating to the activation of the actuator,
   the computer server carrying out the determined operation in response to the message transmitted by the wireless access point router modem.

### FIELD OF THE ART

The present invention pertains to the general field of mail processing and it relates more particularly to a system for controlling an operation on a remote server linked with the sender of an item of mail on the basis of a physical action exerted on a determined zone of a document extracted from this item of mail by its recipient.

### PRIOR ART

Today, when an item of mail received includes a document referring to further information available at the address of the Internet site of its sender, it is necessary to copy this address into one's Web browser in order to gain access to this additional information. If this document does not comprise such a reference, it may then be necessary to telephone or else to return a reply envelope attached to the document in the item of mail, these two operations possibly being at the expense of the recipient of this mail.

Now, very frequently, this further information is not requested from the sender and much time and money may thus be lost, in particular by this sender, on account of this non-reply.

This is why it is known to affix 2D bar codes, known by the name “flash code”, to such documents and which, once read by the photographic sensor of a portable telephone, make it possible to establish a connection with a remote server of an Internet site so as to access the information sought. Nevertheless, this solution is expensive for the owner of the telephone and once connected to the site, navigation on the screen of the portable telephone turns out in general to be very impractical and in particular very poorly suited to the reception of sometimes voluminous information.

A system is also known, through patent application EP 0 986 020, making it possible to perform actions by activating RFID transponders stuck to an object forming a remote control, this activation making it possible to read the associated information by means of an RFID reader/interrogator linked to a computer. This solution nevertheless assumes that the sender can be near the RFID reader/interrogator.

Thus, there is today no simple and fast process allowing the sender of an item of mail to be informed immediately upon receipt at his residence of this item of mail by its recipient and for the latter to reply to a enquiry or to request further information associated with a document contained in this item of mail without having to incur expense.

### DISCLOSURE OF THE INVENTION

The object of the present invention is therefore to remedy this drawback by proposing a system for automatically controlling a determined operation at the level of a remote computer server on the basis of a physical action exerted on at least one determined zone of a document, characterized in that it comprises:

a wireless communication circuit supported by the said document and activated by the actuation of at least one actuator disposed under the said at least one determined zone of the said document, and

a wireless access point router modem for transmitting to the said computer server, via a communication network, a message received from the said wireless communication circuit comprising at least one datum identifying a recipient of the said document and at least one datum relating to the activation of the said at least one actuator,

the said remote computer server carrying out the said determined operation in response to the said message retransmitted by the said wireless access point router modem.

Thus, without any specific operation by the recipient other than the activation of contacts on the document contained in the item of mail that he has received, the sender is informed immediately upon receipt of the latter of the interest shown in his products by his prospective customer and can then address him without waiting for the requested further information, very rapidly and without expense, or the order placed. It is no longer necessary to monitor the replies of the prospective customers so as to follow up with reminders since the absence of an immediate reply will be able to signify an absence of interest by the prospective customer in regard to the content of the mail. The mailings can be addressed by the postal administration or any other private courier.

Advantageously, the said datum identifying the recipient is a client code stored in a memory of the said communication circuit or is associated with a client code in a database of the sender of the said document.

The said wireless communication circuit can be a semiconductor component integrated into the said document or an organic component printed on the said document.

In a preferential embodiment, the said wireless communication circuit is a WiFi communication circuit and the said wireless access point router modem is a WiFi access point router modem preferably comprising a DHCP server. The said datum identifying the recipient is then preferably a MAC address of the said WiFi communication circuit associated with a client code in a database of the sender of the said document.

Advantageously, the said physical action consists of a pressure exerted on the said determined zone under which the said actuator is disposed. The said document can be a letter or a reply card.

The invention also relates to the document allowing automatic control of a determined operation at the level of a remote computer server on the basis of a physical action exerted on at least one determined zone of this document, the said document comprising a wireless communication circuit activated by the actuation of at least one actuator disposed under the said at least one determined zone of the said document, characterized in that the effect of this actuation is to transmit to a wireless access point router modem a message destined for the said remote computer server comprising at least one datum identifying a recipient of the said document and at least one datum relating to the activation of the said at least one actuator and necessary for the carrying out of the said determined operation. The said datum identifying the recipient can be a client code or a datum associated with this client code and stored in a memory of the said communication circuit during the sending of the said document or else a unique identifier associated with the said wireless communication circuit, for example a MAC address, and associated with a client code in a database of the sender during the sending of the said document.

The invention also relates to the method implemented in the aforesaid system by means of this document.

### BRIEF DESCRIPTION OF THE DRAWINGS

Other characteristics and advantages of the present invention will be better apparent from the following description, given by way of nonlimiting indication, with regard to the appended drawings, in which:

FIG. 1 shows an exemplary network architecture allowing the implementation of the invention,

FIG. 2 illustrates in detail the internal structure of a document necessary for the implementation of the invention, and

FIG. 3 shows the various steps of the method implemented in the invention.

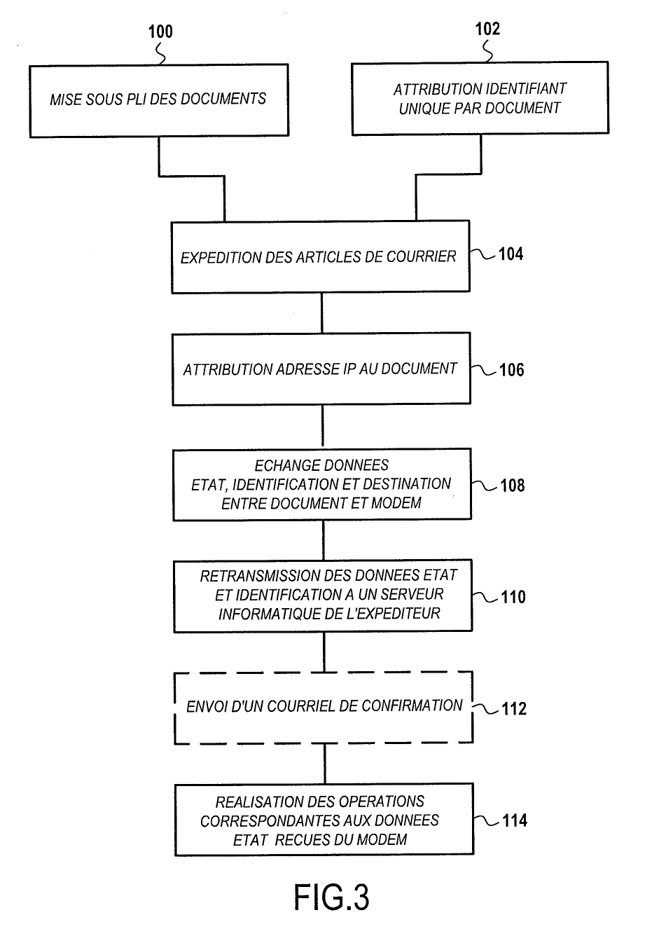

### EMBODIMENT(S) OF THE INVENTION

The principle of the invention relies on the association, at the level of the document inserted into an item of mail, of graphical and electronic elements and the establishment of a data communication between this document and a computer server of the sender of the item of mail.

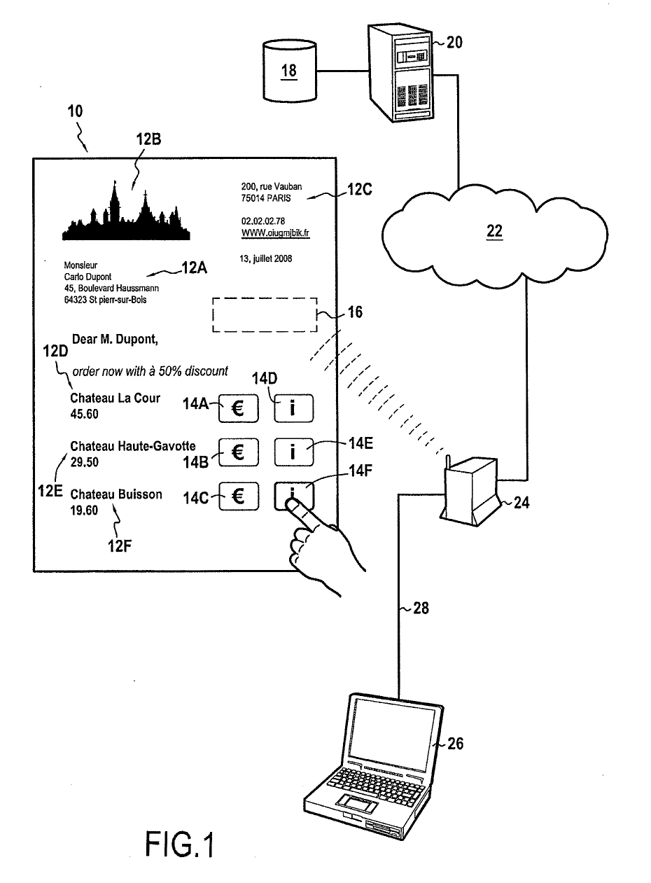

For this purpose and as illustrated by FIG. 1 which shows the network architecture necessary for the implementation of the invention, the sent document 10 comprises graphical or alphanumeric symbols such as the address of the recipient 12A, the logo of the sender 12B, his particulars 12C, and a set of proposals 12D, 12E, 12F in the form of offers, enquiries or questions to which the sender wishes the recipient to reply. In the example illustrated, this involves replying to an offer regarding the purchase of bottles of wine (the names are fictitious), but of course any other application is conceivable, such as replying to a questionnaire within the framework of an opinion poll or a vote on resolutions within the framework of a postal ballot.

With each of these proposals is associated an actuator 14A, 14B, 14C; 14D, 14E, 14F preferably disposed opposite same and identified by a particular graphical element, such as the image of a button, on which a press of the finger will activate the actuator disposed immediately below and constituting an input means of a wireless communication circuit 16 intended to recover fixed data about state (open or closed) or variable data (voltage level for example) provided by each of the actuators and to transmit these data from the document, accompanied by identification and destination data.

According to the invention, the wireless communication circuit is a semiconductor component which can be easily integrated into the paper of the document, for example a component of CMS type. Alternatively, this component can also be printed directly on the document by a polymer printing technique known in organic electronics.

To transmit the data emitted by the wireless communication circuit, the recipient of the item of mail must be in possession of communication means allowing him at one and the same time to cooperate with this electronic circuit of the document and to access a database 18 of a computer server 20 of the sender of the item of mail via a communications network, such as the Internet network 22. Now, today most homes in Europe and the United States possess such communication means 24 known by the name “domestic gateway” integrating at least one wireless access point router modem and allowing on the one hand, by means of a wired communication interface, connection to the Internet network and on the other hand, by means of a wireless communication interface, wireless connection to an internal local network.

Within the framework of the invention, the wireless communication interface is implemented so as to communicate with the wireless communication circuit 16 of the document and the wired communication interface so as to communicate with the computer server via the communication network. The interface for communication with the network is conventionally an ADSL interface or any other interface compatible with the type of network used, for example an optical interface for a fibre optic network. The wireless communication interface and the electronic circuit of the document with which it cooperates are of course subject to a common communication protocol which may be the IEEE 802.11 protocol (known as WiFi) or to any other wireless communication protocol, such as one of the IEEE 802.15 protocols (for example the bluetooth protocol).

The wireless access point router modem can be a single element as illustrated, integrated or not into a domestic gateway, or consist of several separate elements connected one to one, for example an ADSL modem, an Ethernet router and a wireless access point. The recipient's network architecture will usually also comprise at least one computer 26 (and without doubt also a printer, not represented) which can be linked to the wireless access point router modem by wired link by means of an Ethernet cable 28 or wireless cable if it is furnished with an appropriate wireless interface.

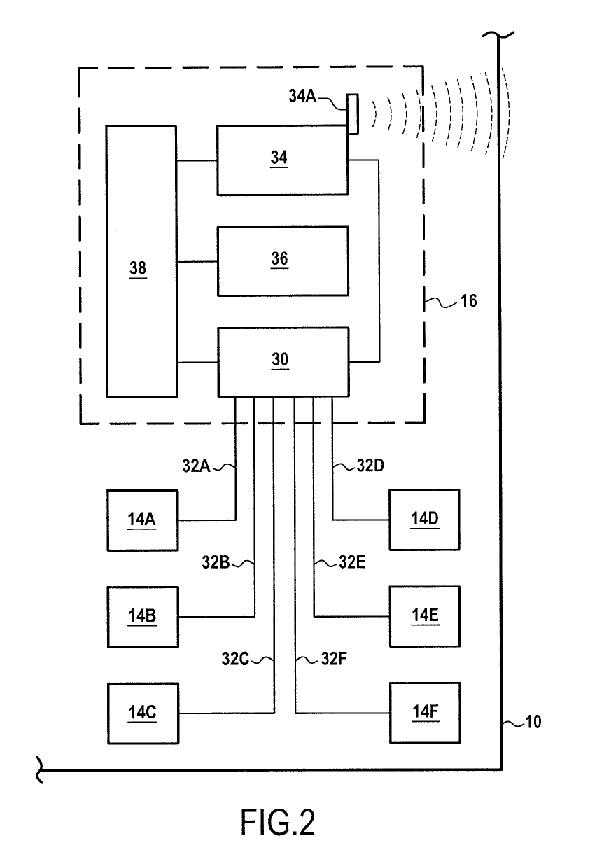

FIG. 2 illustrates in greater detail the internal structure of the wireless communication circuit 16 and its links with the actuators 14A-14F at the level of a document 10 corresponding to the exemplary embodiment of FIG. 1. The wireless communication circuit comprises a processor or microcontroller 30 whose input means consist of the actuators 14A-14F to which it is linked by respective printed links 32A, 32B, 32C, 32D, 32E, 32F and whose state of activation, for example an open or closed state, or else an intermediate state, it is tasked with interpreting. The actuator can use all the known contemporary techniques for its implementation including that of organic electronics. The processor is linked to a wireless emitter 34 integrating an emit/receive antenna 34A and the communication protocol necessary for the bidirectional link of the wireless communication circuit with the associated receiver of the wireless communication interface of the router modem with wireless access point 24. The processor is also linked to a memory 36 of nonvolatile type furthermore comprising the destination data allowing identification of the computer server of the sender who is the recipient of the actuator state data, for example an Internet address, and also the data for identifying the client, a client code or any other code allowing identification thereof as will be specified further on. Finally, a flat battery 38 of paper battery type is provided to power the aforesaid elements constituting the wireless communication circuit.

It will be noted that this architecture with a wireless communication circuit common to all the actuators is not mandatory and it would be conceivable to associate one wireless communication circuit per actuator. In this configuration, the presence of different destination data in each of these communication circuits thus makes it possible to address the state data gathered to different recipients.

The manner in which the process implemented in the invention operates will be now described, without regarding this as a limitation, on the basis of the WiFi communication protocol and it will therefore be convenient to regard the wireless communication circuit of the sent document as being a WiFi communication circuit and the wireless access point router modem as a WiFi access point router modem. Within the framework of this protocol, it will also be convenient to use a DHCP client/server.

The first step 100 is performed at the level of the sender and it consists in the latter posting the documents that he wishes to address to his prospective customers. Each of these documents comprises at least one WiFi communication circuit comprising a unique identifier, preferably the MAC (Medium Access Control) address of this circuit or else a unique identification code independent of this circuit such as the client code or a code associated with the recipient client of the document concerned, known to the sender and which, in a step 102 (which step can proceed in parallel with, prior to or subsequent to step 100), is associated in the sender's client database with the recipient's postal address present on the document. In a following step 104, the items of mail including these documents are sent and distributed to their recipient via a postal administration or a private courier.

At the level of the recipient, assuming that during the reading of the document extracted from the item of mail by the recipient, the latter is in the emit/receive field of his WiFi access point router modem while operational, then, in a step 106, the DHCP server of this modem will automatically and dynamically allocate one or more IP addresses to the WiFi communication circuit or circuits present on this document and in a following step 108 instigate the exchange of the activation, identification and destination data with this or these WiFi communication circuits, this exchange consisting in fact of the transmission by each WiFi communication circuit concerned of a message comprising the datum identifying the recipient, the client code or an associated code or else an identifier of the document (for example its MAC address), the activation data relating to one or more actuators to which it is connected and the destination datum, that is to say of the Internet address (URL) of the computer server of the sender or of an agent of the latter at which this message must arrive.

In a following step 110, the WiFi access point router modem will then retransmit in its turn to the Internet address of the sender's computer server and via the Internet network the part of the message comprising the identification of the recipient, for example an identifier of each WiFi communication circuit concerned, such as its MAC address, and the state of activation of the actuator or actuators to which it is connected.

In a final step 114, on the basis of the message received and in particular of the client code extracted from this message and of the state of activation of the actuator or actuators, the sender's computer server will be able to perform the actions corresponding to the state of these actuators, that is to say, in the example illustrated, to address a crate of the bottles of wine ordered. When the message received contains a MAC address or a code associated with the recipient, access to the client database will make it possible to retrieve the recipient concerned and thereafter to proceed likewise.

It will be noted that if the prospective customer is a regular client of the sender, the latter may then have his email address and forward to him immediately upon receipt of the message originating from the recipient's WiFi access point router modem, for example an order confirmation, in an optional step 112, prior to the dispatching of the latter by mail. Alternatively, he may have authorized his access provider to communicate this electronic address to the sender and the access provider will then integrate said address directly into the message addressed to the sender in addition to the aforesaid identification and destination data.

1. System for automatically controlling a determined operation at the level of a remote computer server (20) on the basis of a physical action exerted on at least one determined zone of a document (10), the said document comprising at least one wireless communication circuit (16) activated by the actuation of at least one actuator (14A-14F) disposed under the said at least one determined zone of the said document, characterized in that it furthermore comprises a wireless access point router modem (24) for transmitting to the said computer server, via a communication network (22), a message received from the said wireless communication circuit comprising at least one datum identifying a recipient of the said document and at least one datum relating to the activation of the said at least one actuator, the said remote computer server carrying out the said determined operation in response to the said message retransmitted by the said wireless access point router modem.

2. System according to claim 1, characterized in that the said datum identifying the recipient is a client code stored in a memory (36) of the said communication circuit.

3. System according to claim 1, characterized in that the said datum identifying the recipient is associated with a client code in a database (18) of the sender of the said document.

4. System according to claim 1, characterized in that the said wireless communication circuit is a semiconductor component integrated into the said document or an organic component printed on the said document.

5. System according to claim 1, characterized in that the said wireless communication circuit is a WiFi communication circuit and the said wireless access point router modem is a WiFi access point router modem.

6. System according to claim 5, characterized in that the said WiFi access point router modem comprises a DHCP server.

7. System according to claim 5, characterized in that the said datum identifying the recipient is a MAC address of the said WiFi communication circuit associated with a client code in a database (18) of the sender of the said document.

8. System according to claim 1, characterized in that the said physical action consists of a pressure exerted on the said determined zone under which the said actuator is disposed.

9. System according to claim 1, characterized in that the said document is a letter or a reply card.

10. Document (10) allowing automatic control of a determined operation at the level of a remote computer server (20) on the basis of a physical action exerted on at least one determined zone of this document, the said document comprising a wireless communication circuit (16) activated by the actuation of at least one actuator (14A-14F) disposed under the said at least one determined zone of the said document, characterized in that the effect of this actuation is to transmit to a wireless access point router modem (24) a message destined for the said remote computer server comprising at least one datum identifying a recipient of the said document and at least one datum relating to the activation of the said at least one actuator and necessary for the carrying out of the said determined operation.

11. Document according to claim 10, characterized in that the said datum identifying the recipient is a client code or a datum associated with this client code.

12. Document according to claim 10, characterized in that the said datum identifying the recipient is a unique identifier associated with the said wireless communication circuit, for example a MAC address.

13. Method of automatically controlling a determined operation at the level of a remote computer server (20) on the basis of a physical action exerted on at least one determined zone of a document (10), the said document comprising at least one wireless communication circuit (16) activated by the actuation of at least one actuator (14A-14F) disposed under the said at least one determined zone of the said document, in which method a wireless access point router modem (24) transmits to the said computer server, via a communication network (22), a message received from the said wireless communication circuit comprising at least one datum identifying a recipient of the said document and at least one datum relating to the activation of the said at least one actuator, the said remote computer server carrying out the said determined operation in response to the said message retransmitted by the said wireless access point router modem.

14. Method according to claim 13, characterized in that the said datum identifying the recipient is a client code or a datum associated with this client code and stored in a memory (36) of the said communication circuit during the sending of the said document.

15. Method according to claim 13, characterized in that the said datum identifying the recipient is a unique identifier associated with the said wireless communication circuit, for example a MAC address, and associated with a client code in a database (18) of the sender during the sending of the said document.
